(19) United States
(12) Patent Application Publication
(10) Pub. No.: US 2006/0193328 A1
(43) Pub. Date: Aug. 31, 2006

(54) Network address filter including random access memory

(76) Inventors: Ramana Rao, San Jose, CA (US); Russell Homer, Los Gatos, CA (US); Donald Krall, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/066,692

(22) Filed: Feb. 25, 2005

(51) Int. Cl. H04L 12/56; H04L 12/28

(52) U.S. Cl. 370/395.32

(57) ABSTRACT

A network address filter that includes a random access memory configured to store network address data, a processor, and a comparator. The processor is configured to execute a hash function on input data to obtain a random access memory address that is applied to the random access memory to obtain network address data from the random access memory address. The comparator is configured to compare the input data to the network address data and indicate a match between the input data and the network address data.

### BACKGROUND

Computer system speeds continue to increase and more computer systems are connected to communicate with other computer systems daily. As the volume of digital data communicated between computer systems increases, there is a need to develop higher bandwidth communication links. Often, these communication links are part of a network, such as a local area network (LAN), metro area network (MAN), or a wide area network (WAN).

A network includes network nodes that provide network related functions. Each network node is a grouping of one or more network elements, such as computer systems, and each network node includes one or more communication links connected to the network. Also, each network node is administered as a single entity. Network elements in a network node can be at one or more sites and a single site may contain more than one network node.

Network elements on a network communicate with other network elements on the network by employing some type of suitable network communication, such as unicast communication, broadcast communication, and multicast communication. Network elements typically address other network elements using media access control (MAC) addresses, including broadcast addresses and multicast addresses. In one aspect, each network element includes a MAC address that is a unique value associated with that network element. MAC addresses are also known as hardware addresses or physical addresses.

In unicast communications, data flows from one network element to another network element. The transmitting network element transmits a different copy of the data to each network element that requests the data.

In broadcast communications, one network element transmits data to all other network elements on a network. The transmitting network element transmits the data with a broadcast address that is accepted by all network elements on the network. Most broadcast communications are non-routable and restricted to a local network.

Multicast communications are a hybrid of unicast and broadcast communication. In multicast communications, one network element typically transmits a single copy of the data. This single copy is replicated and directed by routers to a group of network elements that have previously signed up to be part of a group that receives the data (i.e., joined the multicast group). Thus, instead of transmitting a different copy of the data to each network element in the group, the transmitting network element transmits a single copy of the data that is replicated and directed by routers on the network to network elements in the group. In multicast communications, the transmitting network element transmits the data with a multicast address that is accepted by each network element in the group of network elements.

Each network node filters MAC addresses, including broadcast and multicast addresses, to select data traffic intended for network elements at the network node. One technology for filtering addresses includes using content addressable memory (CAM) devices. However, CAM devices can be cost prohibitive. Also, implementing a large CAM in a field programmable gate array (FPGA) or application specific integrated circuit (ASIC) uses a large number of gates or circuits, which can also be cost prohibitive.

For these and other reasons there is a need for the present invention.

### SUMMARY

One aspect of the present invention provides a network address filter that includes a random access memory configured to store network address data, a processor, and a comparator. The processor is configured to execute a hash function on input data to obtain a random access memory address that is applied to the random access memory to obtain network address data from the random access memory address. The comparator is configured to compare the input data to the network address data and indicate a match between the input data and the network address data.

### BRIEF DESCRIPTION OF THE DRAWINGS

FIG. 1 is a diagram illustrating one embodiment of a resilient packet ring (RPR) network.

FIG. 2 is a diagram illustrating one embodiment of a network node according to the present invention.

FIG. 3 is a diagram illustrating the Open System Interconnection (OSI) model in relation to one embodiment of a network device.

FIG. 4 is a diagram illustrating one embodiment of a MAC address filter according to the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

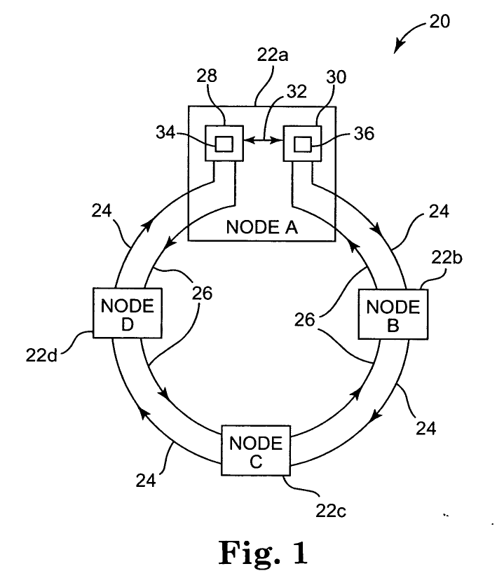

FIG. 1 is a diagram illustrating one embodiment of a resilient packet ring (RPR) network 20. RPR 20 includes network nodes A-D at 22a-22d, respectively, a clockwise communications path 24, and a counter clockwise communications path 26. Each of the nodes A-D at 22a-22d includes one or more network elements and is communicatively coupled to clockwise communications path 24 and to counter clockwise communications path 26. RPR networks are described in IEEE Standard 802.17-2004, Telecommunications And Information Exchange Between Systems—Local And Metropolitan Area Networks—Specific Requirements—Part 17: Resilient Packet Ring (RPR) Access Method & Physical Layer Specifications. In one embodiment, RPR 20 is on a synchronous optical network and synchronous digital hierarchy (SONET/SDH) network infrastructure.

Node A at 22a includes a west device 28 and an east device 30. West device 28 is communicatively coupled to clockwise communications path 24 and counter clockwise communications path 26. East device 30 is communicatively coupled to clockwise communications path 24 and counter clockwise communications path 26. Also, west device 28 is communicatively coupled to east device 30 via communications path 32. Each of the other nodes B-D 22b-22d is similar to node A at 22a. In other embodiments, each of the nodes A-D 22a-22d can be different and include any suitable devices.

West device 28 services one or more network elements. Each of the network elements includes a unique MAC address and each of the network elements can be addressed with other suitable MAC addresses, such as broadcast addresses and multicast addresses. West device 28 receives data packets that include MAC address data for addressing network elements.

West device 28 receives data packets via clockwise communications path 24 and from east device 30 via communications path 32. West device 28 can replicate and route data packets received via clockwise communications path 24 to one or more network elements serviced by west device 28 and/or forward the data packets to east device 30 via communications path 32. East device 30 can forward the data packets received via communications path 32 to other nodes, such as nodes B-D at 22b-22d, via clockwise communications path 24. West device 28 can forward the data packets received from east device 30 via communications path 32 to other nodes, such as nodes B-D at 22b-22d, via counter clockwise communications path 26. In one embodiment, west device 28 can replicate and route data packets received from east device 30 to one or more network elements serviced by west device 28. In one embodiment, west device 28 can transmit data packets received from east device 30 back to east device 30 via communications path 32 and east device 30 can forward the data packets on clockwise communications path 24.

West device 28 includes a MAC address filter 34 that receives MAC address data from each of the data packets that may be replicated and routed to one or more network elements serviced by west device 28. MAC address filter 34 compares the received MAC address data to a list of MAC addresses for network elements serviced by west device 28. If a match is found, west device 28 replicates and routes the received data packet to one or more network elements serviced by west device 28. If a match is not found, west device 28 does not replicate and route the received data packet to one or more network elements serviced by west device 28. In one embodiment, MAC address filter 34 is a multicast address filter that compares multicast address data to multicast addresses for network elements serviced by west device 28. In other embodiments, MAC address filter 34 can be used to compare any suitable MAC addresses or other data inputs to a list of addresses or data entries.

East device 30 services one or more network elements. Each of the network elements includes a unique MAC address and each of the network elements can be addressed with other suitable MAC addresses, such as broadcast addresses and multicast addresses. East device 30 receives data packets that include MAC address data for addressing network elements.

East device 30 receives data packets via counter clockwise communications path 26 and from west device 28 via communications path 32. East device 30 can replicate and route the data packets received via counter clockwise communications path 26 to one or more network elements serviced by east device 30 and/or forward the data packets to west device 28 via communications path 32. West device 28 can forward the data packets received via communications path 32 to other nodes, such as nodes B-D at 22b-22d, via counter clockwise communications path 26. East device 30 can forward the data packets received from west device 28 via communications path 32 to other nodes, such as nodes B-D at 22b-22d, via clockwise communications path 24. In one embodiment, east device 30 can replicate and route data packets received from west device 28 to one or more network elements serviced by east device 30. In one embodiment, east device 30 can transmit data packets received from west device 28 back to west device 28 via communications path 32 and west device 28 can forward the data packets on counter clockwise communications path 26.

East device 30 includes a MAC address filter 36 that receives MAC address data from each of the data packets that may be replicated and routed to one or more network elements serviced by east device 30. MAC address filter 36 compares the received MAC address data to a list of MAC addresses for network elements serviced by east device 30. If a match is found, east device 30 replicates and routes the received data packet to one or more network elements serviced by east device 30. If a match is not found, east device 30 does not replicate and route the received packet to one or more network elements serviced by east device 30. In one embodiment, MAC address filter 36 is a multicast address filter that compares multicast address data to multicast addresses for network elements serviced by east device 30. In other embodiments, MAC address filter 36 can be used to compare any suitable MAC addresses or other data inputs to a list of addresses or data entries.

In an example operation, west device 28 of node A at 22a receives a data packet from a network element at another one of the nodes B-D at 22b-22d via clockwise communications path 24. West device 28 passes MAC address data from the received data packet to MAC address filter 34 that compares the received MAC address data to a list of MAC addresses stored in random address memory. If the compare operation produces a match result hit, west device 28 replicates and routes the received data packet to one or more network elements serviced by west device 28. If the compare operation produces a match result miss, west device 28 does not replicate and route the received data packet to one or more network elements serviced by west device 28. West device 28 transmits the data packet to other network elements in other nodes, such as nodes B-D at 22b-22d. To transmit the data packet to other nodes, west device 28 transmits the data packet to east device 30 via communications path 32 and east device 30 transmits the data packet via clockwise communications path 24.

In another example operation, the roles of west device 28 and east device 30 are reversed. East device 30 of node A at 22a receives a data packet from a network element at another one of the nodes B-D at 22b-22d via counter clockwise communications path 26. East device 30 passes MAC address data from the received data packet to MAC address filter 36 that compares the received MAC address data to a list of MAC addresses stored in random address memory. If the compare operation produces a match result hit, east device 30 replicates and routes the received data packet to one or more network elements serviced by east device 30. If the compare operation produces a match result miss, east device 30 does not replicate and route the received data packet to one or more network elements serviced by east device 30. East device 30 transmits the data packet to other network elements in other nodes, such as nodes B-D at 22b-22d. To transmit the data packet to other nodes, east device 30 transmits the data packet to west device 28 via communications path 32 and west device 28 transmits the data packet via counter clockwise communications path 26.

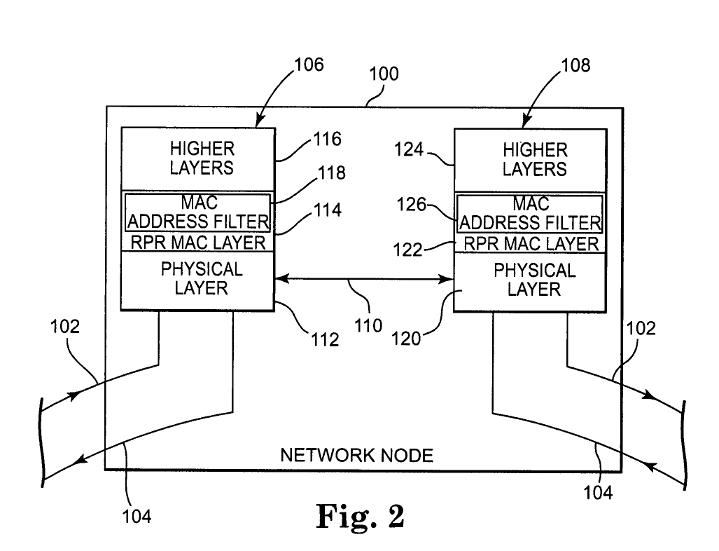

FIG. 2 is a diagram illustrating one embodiment of a network node 100 according to the present invention. Node 100 is similar to node A at 22a (shown in FIG. 1) and part of an RPR network similar to RPR 20 of FIG. 1. Node 100 is communicatively coupled to clockwise communications path 102 and counter clockwise communications path 104. Clockwise communications path 102 is similar to clockwise communications path 24 and counter clockwise communications path 104 is similar to counter clockwise communications path 26. In other embodiments, node 100 can be part of any suitable network.

Node 100 includes a west device 106 and an east device 108. West device 106 is similar to west device 28 and east device 108 is similar to east device 30. West device 106 is communicatively coupled to clockwise communications path 102 and to counter clockwise communications path 104. East device 108 is communicatively coupled to clockwise communications path 102 and to counter clockwise communications path 104. Also, west device 106 and east device 108 are communicatively coupled via communications path 110 to communicate bi-directionally with each other.

West device 106 includes a physical layer 112, an RPR MAC layer 114, and higher layers 116. Physical layer 112 is similar to physical layer 1 of the Open System Interconnection (OSI) model that is the standard description or reference model that defines a framework for implementing protocols to communicate messages in a communications system. RPR MAC layer 114 is similar to the MAC sub-layer in the data link layer 2 of the OSI model. Higher layers 116 include the rest of the data link layer 2 and other layers in the seven layer OSI model.

Physical layer 112 communicates with RPR MAC layer 114 and is communicatively coupled to clockwise communications path 102 and counter clockwise communications path 104. Physical layer 112 conveys a bit stream through the RPR network at the electrical and mechanical level. The bit stream can be conveyed through electrical impulses, radio signals, light, or any suitable transmission technology. Physical layer 112 provides the hardware for sending and receiving data on a carrier, including cables, cards, and other physical aspects. In one embodiment, physical layer 112 includes a serial LAN physical layer, such as an Ethernet serial LAN physical layer. In one embodiment, physical layer 112 includes a WAN physical layer, such as a WAN physical layer for interfacing to a SONET/SDH network. In one embodiment, physical layer 112 includes a WAN physical layer for interfacing Ethernet packets to a SONET/SDH network infrastructure.

RPR MAC layer 114 controls sharing physical layer 112 among several network elements, including how a network element gains access to data and permission to transmit data. RPR MAC layer 114 controls filtering data packets for network elements serviced by west device 106. RPR MAC layer 114 includes a MAC address filter 118 that receives MAC address data from data packets that are received by physical layer 112 and RPR MAC layer 114 via clockwise communications path 102 and communications path 110. MAC address filter 118 compares the received MAC address data to a list of MAC addresses for network elements serviced by west device 106. If a match is found, west device 106 replicates and routes the received data packet to one or more network elements serviced by west device 106 by passing the data packet to higher layers 116. If a match is not found, west device 106 does not replicate and route the received data packet to one or more network elements serviced by west device 106. West device 106 can transmit received data packets to east device 108 via communications path 110 and east device 108 can transmit the data packets to other nodes via clockwise communications path 102. In one embodiment, MAC address filter 118 is a multicast address filter that compares multicast address data to multicast addresses for network elements serviced by west device 106. In other embodiments, MAC address filter 118 can be used to compare any suitable MAC addresses or other data inputs to a list of addresses or data entries.

East device 108 includes a physical layer 120, an RPR MAC layer 122, and higher layers 124. Physical layer 120 is similar to physical layer 1 of the Open System Interconnection (OSI) model and RPR MAC layer 122 is similar to the MAC sub-layer in the data link layer 2 of the OSI model. Higher layers 124 include the rest of the data link layer 2 and other layers in the seven layer OSI model.

Physical layer 120 communicates with RPR MAC layer 122 and is communicatively coupled to clockwise communications path 102 and counter clockwise communications path 104. Physical layer 120 conveys a bit stream through the RPR network at the electrical and mechanical level. The bit stream can be conveyed through electrical impulses, radio signals, light, or any suitable transmission technology. Physical layer 120 provides the hardware for sending and receiving data on a carrier, including cables, cards, and other physical aspects. In one embodiment, physical layer 120 includes a serial LAN physical layer, such as an Ethernet serial LAN physical layer. In one embodiment, physical layer 120 includes a WAN physical layer, such as a WAN physical layer for interfacing to a SONET/SDH network. In one embodiment, physical layer 120 includes a WAN physical layer for interfacing Ethernet packets to a SONET/SDH network infrastructure.

RPR MAC layer 122 controls sharing physical layer 120 among several network elements, including how a network element gains access to data and permission to transmit data. RPR MAC layer 122 controls filtering data packets for network elements serviced by east device 108. RPR MAC layer 122 includes a MAC address filter 126 that receives MAC address data from data packets that are received by physical layer 120 and RPR MAC layer 122 via counter clockwise communications path 104 and communications path 110. MAC address filter 126 compares the received MAC address data to a list of MAC addresses for network elements serviced by east device 108. If a match is found, east device 108 replicates and routes the received data packet to one or more network elements serviced by east device 108 by passing the data packet to higher layers 124. If a match is not found, east device 108 does not replicate and route the received data packet to one or more network elements serviced by east device 108. East device 108 can transmit received data packets to west device 106 via communications path 110 and west device 106 can transmit the data packets to other nodes via counter clockwise communications path 104. In one embodiment, MAC address filter 126 is a multicast address filter that compares multicast address data to multicast addresses for network elements serviced by east device 108. In other embodiments, MAC address filter 126 can be used to compare any suitable MAC addresses or other data inputs to a list of addresses or data entries.

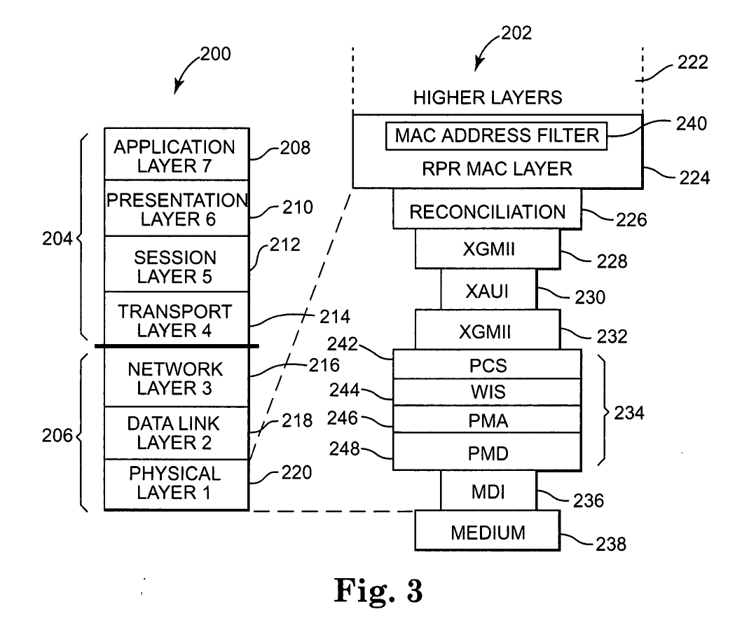

FIG. 3 is a diagram illustrating the OSI model 200 in relation to one embodiment of a network device 202. OSI model 200 is the standard description or reference model that defines a framework for implementing protocols to communicate in a system. Network device 202 is similar to west device 106 and east device 108 (shown in FIG. 2).

Network device 202 includes a WAN physical layer for interfacing Ethernet packets to a SONET/SDH network infrastructure. Network device 202 operates at 10 Gbps. In other embodiments, network device 202 can include a serial LAN physical layer, such as an Ethernet serial LAN physical layer. Also, in other embodiments, network device 202 can be configured to operate at any suitable bit frequency.

OSI model 200 includes an end user group of layers, indicated at 204, and a networking group of layers, indicated at 206. The end user group of layers 204 passes messages to and from an end user. The networking group of layers 206 passes messages through the host. Messages intended for the host are received by the networking group of layers 206 and passed through the networking group of layers 206 to the end user group of layers 204. Messages destined only for another host are not passed to the end user group of layers 204. Instead, messages destined for only another host are passed through the networking group of layers 206 to the other host.

The end user group of layers 204 includes application layer 7 at 208, presentation layer 6 at 210, session layer 5 at 212, and transport layer 4 at 214. Application layer 7 at 208 supports application and end user processes. In application layer 7 at 208, communication partners are identified, quality of service is identified, user authentication and privacy are considered, and any constraints on data syntax are identified. Application layer 7 at 208 is not the application itself, but is application specific, and some applications may perform application layer 7 functions. Telnet and file transfer protocol (FTP) are programs that can exist entirely in application layer 7 at 208.

Presentation layer 6 at 210 provides independence from differences in data representation by translating data from application to network format, and vice versa. The presentation layer 6 at 210 transforms data into the form that the application layer can accept and formats and encrypts data to be sent across a network. Presentation layer 6 at 210 is usually part of an operating system and is sometimes called the syntax layer.

Session layer 5 at 212 deals with session and connection coordination. Session layer 5 at 212 establishes, manages, and terminates connections between applications. Session layer 5 at 212 also coordinates conversations, exchanges, and dialogs between the applications.

Transport layer 4 at 214 ensures complete data transfer. Transport layer 4 at 214 provides transparent transfer of data between end systems or hosts, and is responsible for end-to-end error recovery and flow control.

The networking group of layers 206 includes network layer 3 at 216, data link layer 2 at 218, and physical layer 1 at 220. Network layer 3 at 216 provides switching and routing technologies. Network layer 3 at 216 handles the routing of data, sending data in the right direction to the right destination on outgoing transmissions and receiving incoming transmissions. In addition, network layer 3 at 216 handles forwarding, addressing, error handling, congestion control, and packet sequencing.

Data link layer 2 at 218 furnishes transmission protocol knowledge and management. In data link layer 2 at 218, data packets are encoded and decoded into bits. Data link layer 2 at 218 handles errors in the physical layer, flow control, and frame synchronization. Data link layer 2 at 218 includes a logical link control (LLC) layer that is part of higher layers at 222 and an RPR MAC layer at 224. The LLC layer controls error checking, flow control, and frame synchronization. RPR MAC layer 224 controls sharing a physical connection among several network elements including how a network element gains access to data and permission to transmit data. RPR MAC layer 224 is similar to RPR MAC layer 114 (shown in FIG. 2) and RPR MAC layer 122 (shown in FIG. 2).

Physical layer 1 at 220 conveys a bit stream through the network at the electrical and mechanical level. The bit stream can be conveyed through electrical impulses, radio signals, light, or any suitable transmission technology. Physical layer 1 provides the hardware for sending and receiving data on a carrier, including cables, cards, and other physical aspects. SONET/SDH and Ethernet protocols are protocols with physical layer components.

Network device 202 includes higher layers at 222 and RPR MAC layer 224. The higher layers at 222 include the LLC layer and other layers in OSI model 200. RPR MAC layer 224 is part of data link layer 2 at 218. Network device 202 also includes a reconciliation sub-layer (RS) 226, a 10 Gbps media independent interface (XGMII) 228, a 10 Gbps attachment unit interface (XAUI) 230, a physical side XGMII 232, a physical layer device 234, and a medium dependent interface (MDI) 236, which are part of physical layer 1 at 220.

MDI 236 is attached to a medium 238 to send and receive messages through network device 202. Medium 238 carries electrical impulses, radio signals, or light from one communication link to another. Medium 238 is similar to clockwise and counter clockwise communication paths 102 and 104 (shown in FIG. 2). In one embodiment, medium 238 is a pair of fiber optic cables. In one embodiment, medium 238 is a twisted pair of copper wires. In other embodiments, medium 238 is any suitable medium for carrying electrical impulses, radio signals, or light.

RPR MAC layer 224 is the lower portion of data link layer 2 at 218 and one of the interface layers between higher layers 222 and physical layer 1 at 220. RPR MAC layer 224 can be different for different physical media and is responsible for controlling inbound and outbound communications between physical layer 1 at 220 and higher layers 222 of OSI model 200. RPR MAC layer 224 breaks data into data frames or packets, transmits the data packets sequentially, processes acknowledgement frames, handles address recognition, and controls access to medium 238.

For outbound communications, RPR MAC layer 224 divides data meant for transmission into a series of data packets formatted for physical layer 1 at 220. Within each data packet, RPR MAC layer 224 adds a unique layer 2 address that is the MAC address, which identifies the network element sending the transmission. The MAC address can be incorporated in hardware or software. RPR Mac layer 224 also adds the MAC address of the destination network element. RPR MAC layer 224 organizes the data packets sequentially and presents them one at a time to physical layer 1 at 220 for transmission across medium 238. After a destination network element receives a transmitted data packet, the destination sends an acknowledgement frame. The transmitting network element transmits the next data packet in the sequence until all data packets are transmitted and confirmed. If an acknowledgement frame is not received after a certain amount of time, the transmitting network element automatically resends the unacknowledged data packet.

For inbound communications, RPR MAC layer 224 receives data packets and provides MAC address recognition to service network elements at network device 200. RPR MAC layer 224 includes a MAC address filter 240 that receives the destination MAC address from each received data packet. MAC address filter 240 provides an index into memory for each received destination MAC address and compares the received destination MAC address to the contents of memory at the indexed location to obtain a match result. If the match result is a hit, the data packet is replicated and routed to one or more network elements serviced by network device 200 and an acknowledgement frame is sent to indicate the data packet was received. If the match result was a miss, the data packet is not replicated and routed to one or more network elements serviced by network device 200 and an acknowledgement frame is not sent. If data packets are lost during transmission, the transmitting network element does not receive an acknowledgement frame and the lost packets are automatically resent until an acknowledgement frame is received. Ethernet is a protocol that works at RPR MAC layer 224. In one embodiment, MAC address filter 240 filters multicast address for network elements at network device 202.

RS 226 is situated between RPR MAC layer 224 and XGMII 228. RS 226 operates as a command translator and maps the terminology and commands used in RPR MAC layer 224 into electrical formats appropriate for entities in physical layer 1 at 220, and vice versa. In one embodiment, RS 226 adapts bit serial protocols of RPR MAC layer 224 to parallel encodings of 10 Gbps physical layer devices 234.

XGMII 228 is situated between RS 226 and XAUI 230. XGMII 228 provides a standard interconnection between RPR MAC layer 224 and physical layer devices 234. XGMII 228 isolates RPR MAC layer 224 from physical layer devices 234 to enable RPR MAC layer 224 to be used with various implementations of physical layer 1 at 220. XGMII 228 supports 10 Gbps operations with a 32 bit wide transmit data path and a 32 bit wide received bit path. XGMII 228 also includes 4 transmit control signals and a transmit clock, and 4 receive control signals and a receive clock to provide full duplex operation. Each direction of data transfer is independent and serviced by independent data, control, and clock signals.

XGMII 228 balances the need for media independence with the need for a simple and cost effective interface. The bus width and signaling rate are applicable to short distance integrated circuit chip-to-chip interconnections with printed circuit board trace lengths electrically limited to about 7 centimeters (cm). XGMII 228 is described in IEEE Std 802.3ae entitled “Part 3: Carrier Sense Multiple Access with Collision Detection (CSMA/CD) Access Method and Physical Layer Specifications, Amendment: Media Access Control (MAC) Perimeters, Physical Layers, and Management Perimeters for 10 Gb/s Operation.”

XAUI 230 provides an interconnection between XGMII 228 and physical side XGMII 232. XAUI 230 can be used to extend the operational distance of the XGMII interface and reduce the number of interface signals. XAUI 230 can be an integrated circuit chip-to-chip interface with printed circuit board trace lengths of up to about 50 cm. XAUI 230 supports a 10 Gbps data rate between XGMII 228 and XGMII 232 via four differential pair transmit paths and four differential pair receive paths. Applications include extending the physical separation between RPR MAC layer 224 and physical layer devices 234 in a 10 Gbps Ethernet system.

XAUI 230 is inserted between RS 226 and physical layer devices 234 to transparently extend the physical reach of the XGMII interface and reduce the XGMII interface pin count. The XGMII interface is organized into four transmit lanes with each lane conveying a data octet on each edge of the associated clock, and four receive lanes with each lane conveying a data octet on each edge of the associated clock. Each of the four XGMII transmit lanes is transmitted across one of the four XAUI differential pair transmit paths and each of the four XGMII receive lanes is transmitted across one of the four XAUI differential pair receive paths. Each of the XAUI transmit paths and each of the XAUI receive paths is a serial, independent data path that uses low voltage swing differential signaling. Thus, XAUI 230 includes four differential pair transmit paths or eight transmit lines and four differential pair receive paths or eight receive lines. XAUI 230 is further described in IEEE Std 802.3ae, previously referenced herein.

Physical side XGMII 232 is similar to XGMII 228. Physical side XGMII 232 provides an interconnection between XAUI 230 and physical layer devices 234. Physical side XGMII 232 supports 10 Gpbs operation through a 32 bit wide transmit path and a 32 bit wide receive path. Physical side XGMII 232 provides four transmit control signals and a transmit clock and four receive control signals and a receive clock to provide full duplex operation. Each direction of data transfer is independent and serviced by data, control, and clock signals. The serial data from XAUI 230 is converted into 32 bit wide transmit and 32 bit wide receive data streams transported through physical side XGMII 232. Physical layer devices 234 communicate with physical side XGMII 232 through the 32 bit wide transmit and 32 bit wide receive data paths. Physical side XGMII 232 is further described in IEEE Std 803.2ae, previously referenced herein.

Physical layer devices 234 include physical coding sub-layer (PCS) 242, WAN interface sub-layer (WIS) 244, physical medium attachment (PMA) 246, and physical medium dependent layer (PMD) 248. PCS 242 is positioned between physical side XGMII 232 and WIS 244 and is responsible for encoding data streams from RPR MAC layer 224 for transmission through medium 238, and decoding data streams received through medium 238 for RPR MAC layer 224. WIS 244 is situated between PCS 242 and PMA 246 and is responsible for adapting a serial LAN physical layer, such as Ethernet, to a WAN interface, such as a SONET/SDH network, where WIS 244 is responsible for SONET framing, SONET overhead processing and scrambling. PMA 246 is situated between WIS 244 and PMD 248 and is responsible for serializing code groups into bit streams suitable for serial bit oriented physical devices, and vice versa. Also, PMA 246 synchronizes data for proper data decoding. PMD 248 is situated between PMA 246 and MDI 236 and is responsible for signal transmissions. PMD 248 can include an amplifier, modulation, and wave shaping. MDI 236 is a connector, where a different connector type is used for a different PMD 248 and/or a different physical medium 238.

In operation, each user or program is at a device equipped with the seven layers of OSI model 200. In a given communication between users, data flows through application layer 7 at 208 to presentation layer 6 at 210 and down through the other layers of OSI model 200, including physical layer 1 at 220 of the transmitting device. The communication is received at a receiving device and flows through physical layer 1 at 220 to data link layer 2 at 218 and up through the other layers of OSI model 200, including application layer 7 at 208 of the receiving device and ultimately to the end user or program.

As the communication is transmitted through data link layer 2 at 218, the communication travels to RPR MAC layer 224 that controls dividing the communication into a series of data packets formatted for the physical interface. RPR MAC layer 224 adds a unique MAC address to each data packet identifying the network element that sent the transmission and a MAC address identifying the destination network element.

Next, the data packets are transferred to RS 226 that provides a mapping between the signals provided by RPR MAC layer 224 and the signals needed at XGMII 228. RS 226 operates as a command translator. XGMII 228 receives the data packets from RS 226 and transmits the data packets in a 32 bit wide transmit path. The 32 bit wide transmit path is converted into four serial data paths that are transmitted through XAUI 230 at a data rate of approximately 3.125 Gbps on each of the four data paths. The four serial data streams are converted into a 32 bit wide transmit path that is transported through physical side XGMII 232 to PCS 242. The data packets travel through PCS 242, WIS 244, PMA 246, and PMD 248 to MDI 236 and medium 238.

A receiving device, receives the data packets via medium 238 and the receiving devices MDI 236. The data packets are transported through the receiving devices PMD 248, PMA 246, WIS 244, and PCS 242 to the receiving devices physical side XGMII 232. The 32 bit wide data stream received at physical side XGMII 232 is converted into four serial data streams and transported through XAUI 230 at 3.125 Gbps on each of the four data streams to XGMII 228. The four serial data streams are converted into 32 bit wide data streams and transported through XGMII 228 to RS 226 that maps the received data packets to the receiving devices RPR MAC layer 224. As each data packet of the communication is received by RPR MAC layer 224, the destination MAC address of the data packet is passed to MAC address filter 240 that provides an index into memory for each received destination MAC address and compares the received destination MAC address to the contents of memory at the indexed location to obtain a match result. If the match result is a hit, the data packet is replicated and transferred to higher layers 222 and an acknowledgement frame is sent to indicate the data packet was received. If the match result was a miss, the data packet is not replicated and transferred to higher layers 222 and an acknowledgement frame is not sent.

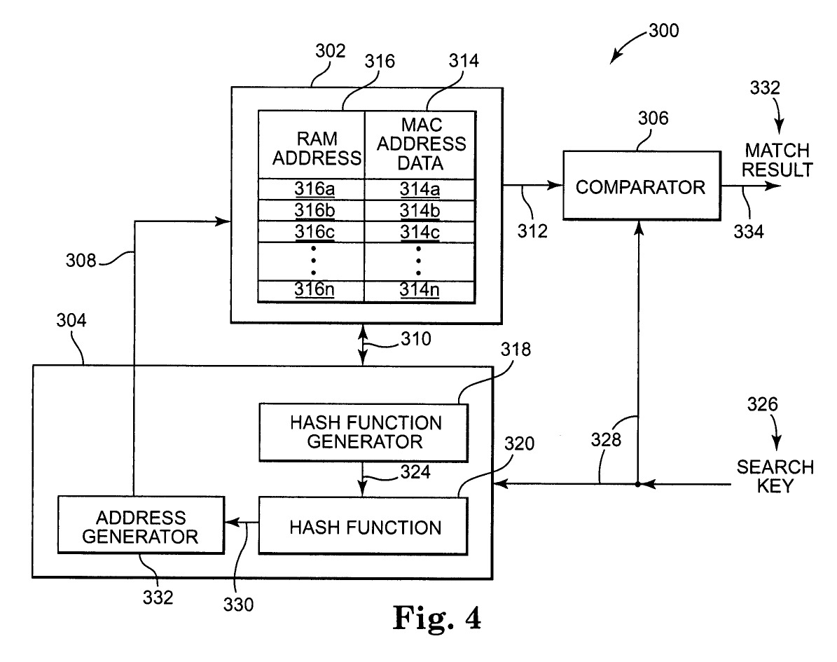

FIG. 4 is a diagram illustrating one embodiment of a MAC address filter 300 according to the present invention. MAC address filter 300 can be part of any network device, such as west device 28 and east device 30 (shown in FIG. 1), west device 106 and east device 108 (shown in FIG. 2), and network device 202 (shown in FIG. 3). MAC address filter 300 is similar to each of the MAC address filters 34 and 36, each of the MAC address filters 118 and 126, and MAC address filter 240. Also, MAC address filter 300 can be implemented in hardware, software, firmware, or any combination thereof.

MAC address filter 300 includes random access memory (RAM) 302, a processor 304, and a comparator 306. RAM 302 is electrically coupled to processor 304 via address path 308 and bi-directional data path 310. Also, RAM 302 is electrically coupled to comparator 306 via output data path 312.

RAM 302 can be any suitable memory, such as a stand alone memory device or part of another suitable device, such as processor 304, a larger RAM memory device, a microprocessor, a microcontroller, a digital signal processor (DSP), an application specific integrated circuit (ASIC) or a field programmable gate array (FPGA). Also, RAM 302 can be any suitable type of RAM, such as static RAM (SRAM) or dynamic RAM (DRAM).

RAM 302 stores MAC address data 314 in RAM addresses 316. MAC address data 314a is stored in RAM address 316a, MAC address data 314b is stored in RAM address 316b, MAC address data 314c is stored in RAM address 316c, and so on, up to MAC address data 314n being stored in RAM address 316n. To read MAC address data 314 from RAM 302, one of the RAM addresses 316a-316n is provided to RAM 302 via address path 308 and the corresponding MAC address data 314a-314n is output by RAM 302. RAM 302 outputs MAC address data 314a-314n to processor 304 via bi-directional data path 310 and to comparator 306 via output data path 312.

Processor 304 can be any suitable processor, such as a microprocessor, a microcontroller, a DSP, a processor in an ASIC, or a processor in an FPGA. MAC address filter 300 includes a hash function generator 318, a hash function 320, and an address generator 322, which are software programs executed by processor 304. In other embodiments, any or all of the functions of hash function generator 318, hash function 320, and address generator 322 can be built into hardware, such as an ASIC or FPGA. In other embodiments, any or all of the functions of hash function generator 318, hash function 320, and address generator 322 can be implemented in hardware, software, firmware, or any combination thereof.

Processor 304 executes hash function generator 318, which produces hash function 320, indicated at 324. While executing hash function generator 318, processor 304 addresses each of the RAM addresses 316a-316n to obtain MAC address data 314a-314n. Processor 304 executes hash function generator 318 to analyze RAM addresses 316a-316n and corresponding MAC address data 314a-314n and produce hash function 320.

In one embodiment, processor 304 executes hash function generator 318 to produce a completely new hash function in the event the MAC address data 314 is modified in RAM 302. Modifying MAC address data 314 includes changing or adding MAC address data to RAM 302. In one embodiment, new MAC address data is inserted into currently unused RAM address locations and processor 304 executes hash function generator 318 to update hash function 320, such that a completely new hash function is not produced and only minor modifications are made to the data structures that are part of the initial hash function 320.

In one embodiment, processor 304 executes hash function generator 318 to delete MAC address data 314 from RAM 302. In one embodiment, MAC address data 314a-314n is changed to a value that indicates the MAC address data 314a-314n is not valid. In one embodiment, a flag is stored with the MAC address data 314a-314n at each of the RAM addresses 316a-316n and the flag is set to indicate the corresponding MAC address data 314a-314n is deleted. In one embodiment, an auxiliary file is maintained to indicate deleted MAC address data 314a-314n.

Hash function 320 is a mathematical function that yields an index value for each input pattern or search key 326. Wherein, a mathematical function relates input values and output values, such that every input value is associated with exactly one output value. Also, multiple input values can be associated with the same output value. However, one input value is associated with only one output value. The domain of a mathematical function is the set of all values accepted as input by the function and the range of the function is the set of all output values produced by the function. A hash function belongs to a class of mathematical functions wherein the size of the range is much smaller than the size of the domain.

In one embodiment, hash function 320 is a minimal perfect hash function. Wherein, a perfect hash function produces a unique output value for each input value in a specified subset of the domain of the function and a minimal perfect hash function is a perfect hash function that produces unique output values in a specified range. The minimal perfect hash function is referred to as perfect based on one index value being produced for each search key 326, where the same index value is produced each time from the same search key 326. The minimal perfect hash function is referred to as minimal based on the RAM addresses 316a-316n being addressed using the index values. In the context of network MAC addresses that may be 48-bits in length, the domain of the hash function contains over 281 trillion unique addresses. However, a network address filter usually needs to filter only an exceedingly small subset of this domain. For example, for 16 selected network addresses, it is possible to construct a minimal perfect hash function that produces output values 1 through 16. In other embodiments, hash function 320 can be any suitable function, such as a perfect hash function.

Processor 304 receives search key 326 at input path 328 and executes hash function 320 on the received search key 326. Processor 304 executes hash function 320 on the received search key 326 to produce an index value that is passed to address generator 322 via index path 330. Processor 304 executes address generator 322 on the received index value to produce one of the RAM addresses 316a-316n that addresses RAM 302 to obtain the corresponding MAC address data 314a-314n as output.

Comparator 306 is a hardware comparator that can be any suitable comparator, such as a stand alone comparator or part of any suitable device, such as a microprocessor, microcontroller, DSP, ASIC, or FPGA. Comparator 306 compares two inputs and produces a match result 332 on output path 334. Comparator 306 receives search key 326 via input path 328 and MAC address data 314a-314n via output data path 312. Comparator 306 compares search key 326 to the received MAC address data 314a-314n. If search key 326 and the received MAC address data 314a-314n are the same, comparator 306 produces a match result hit 332. If search key 326 and the received MAC address data 314a-314n are different, comparator 306 produces a match result miss 332. In other embodiments, comparator 306 can be a software program executed by processor 304. In other embodiments, comparator 306 can be implemented in hardware, software, firmware, or any combination thereof.

In operation, MAC address data 314a-314n is stored in RAM addresses 316a-316n of RAM 302. Processor 304 executes hash function generator 318 to produce hash function 320. In one embodiment, each entry of MAC address data 314a-314n includes a multicast MAC address or part of a multicast MAC address.

In one embodiment, in the event the MAC address data 314 is modified, processor 304 executes hash function generator 318 to produce a new hash function 320. In one embodiment, in the event the MAC address data 314 is modified, processor 304 executes hash function generator 318 to update hash function 320. In one embodiment, in the event MAC address data 314 is deleted, processor 304 executes hash function generator 318 to change the deleted MAC address data 314 to an invalid value. In one embodiment, in the event MAC address data 314 is deleted, processor 304 executes hash function generator 318 to set a flag for the deleted MAC address data 314.

A search key 326 is provided to processor 304 and comparator 306 via input path 328. Processor 304 receives search key 326 and executes hash function 320 on the received search key 326. Processor 304 executes hash function 320 on the received search key 326 to produce an index value that is passed to address generator 322 via index path 330. Processor 304 executes address generator 322 on the received index value to produce one of the RAM addresses 316a-316n that addresses RAM 302. In response, RAM 302 outputs the corresponding MAC address data 314a-314n to comparator 306 via output data path 312. Search key 326 is provided by a MAC layer, such as each of RPR MAC layers 114 and 122 (shown in FIG. 2) and RPR MAC layer 224 (shown in FIG. 3). In one embodiment, search key 326 includes a multicast MAC address or part of a multicast MAC address.

Comparator 306 receives search key 326 via input path 328 and MAC address data 314a-314n via output data path 312. Comparator 306 compares search key 326 to the received MAC address data 314a-314n. If search key 326 and the received MAC address data 314a-314n are the same, comparator 306 produces a match result hit 332. If search key 326 and the received MAC address data 314a-314n are different, comparator 306 produces a match result miss 332. In the event match result 332 is a hit, the network device that includes MAC address filter 300 replicates and routes the data packet that includes search key 326 to one or more network elements serviced by the network device. In the event match result 332 is a miss, the network device that includes MAC address filter 300 does not replicate and route the data packet that includes search key 326 to one or more network elements serviced by the network device.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A network address filter, comprising:
a random access memory configured to store network address data;
a processor configured to execute a hash function on input data to obtain a random access memory address that is applied to the random access memory to obtain network address data from the random access memory address; and
a comparator configured to compare the input data to the network address data and indicate a match between the input data and the network address data.

2. The network address filter of claim 1, wherein the processor is configured to execute the hash function to obtain an index that is used to obtain the random access memory address.

3. The network address filter of claim 1, wherein the hash function is a minimal perfect hash function and the processor is configured to execute the minimal perfect hash function to obtain the random access memory address.

4. The network address filter of claim 1, wherein the processor is configured to read the network address data from the random access memory and generate the hash function based on the network address data in the random access memory.

5. The network address filter of claim 4, wherein the processor is configured to generate a new hash function that replaces the hash function if the network address data in the random access memory is modified.

6. The network address filter of claim 4, wherein the processor is configured to update the hash function if the network address data in the random access memory is modified.

7. The network address filter of claim 1, wherein the processor is configured to change the network address data stored in the random access memory to delete the network address data from the random access memory.

8. The network address filter of claim 1, wherein the processor is configured to maintain an auxiliary table that indicates valid network address data in the random access memory.

9. The network address filter of claim 1, wherein the processor is configured to maintain flags that indicate valid network address data in the random access memory.

10. The network address filter of claim 1, wherein the comparator is a hardware comparator.

11. A network system comprising:
a network node configured to receive a packet that includes multicast address data, the network node comprising:
a random access memory configured to store multicast address entries; and
a processor configured to execute a hash function on the multicast address data to obtain a random access memory address that is applied to the random access memory to obtain the multicast address entry stored at the random access memory address as an output that is compared to the multicast address data to obtain a match result.

12. The network system of claim 11, wherein the network node is configured to replicate and route the packet to one or more serviced network elements in the event the match result is a hit.

13. The network system of claim 11, comprising:
a hardware comparator that compares the output to the multicast address data to obtain the match result.

14. The network system of claim 11, wherein the network node is coupled to a resilient packet ring network to receive the packet that includes the multicast address data.

15. An address filter, comprising:
means for storing address data;
means for obtaining address data from the means for storing address data;
means for comparing input data to the address data to indicate a match between the input data and the address data.

16. The address filter of claim 15, wherein the means for obtaining address data comprises;
means for executing a hash function to obtain an index that is used to obtain an address.

17. The address filter of claim 15, wherein the means for obtaining address data comprises;
means for executing a minimal perfect hash function to obtain an address.

18. The address filter of claim 15, comprising:
means for reading the address data from the means for storing address data; and
means for generating a hash function based on the address data in the means for storing address data.

19. The address filter of claim 15, comprising:
means for revising a hash function if the address data in the means for storing address data is modified.

20. A method of network address filtering comprising:
receiving a packet that includes network address data;
executing a hash function on the network address data to obtain a random access memory address;
reading a network address data entry at the random access memory address of a random access memory; and
comparing the network address data entry read from the random access memory to the network address data to obtain a match result.

21. The method of claim 20, wherein executing a hash function comprises;
executing a minimal perfect hash function with a processor to obtain an index; and
obtaining a random access memory address using the index.

22. The method of claim 20, comprising:
reading the random access memory to obtain network address data entries;
executing a hash function generator to obtain the hash function for the network address data entries.

23. The method of claim 22, comprising:
re-executing the hash function generator to generate a new hash function that replaces the hash function if the network address data in the random access memory is modified.

24. The method of claim 22, comprising:
executing a hash function update program to update the hash function if the network address data in the random access memory is modified.

25. The method of claim 20, comprising deleting a selected network address data entry from the random access memory by at least one of:
changing the selected network address data entry in the random access memory;
maintaining an auxiliary table that indicates the selected network address data entry is invalid; and
maintaining a flag that indicates the selected network address data entry is invalid.
